(19) United States
(12) Patent Application Publication
(10) Pub. No.: US 2007/0094446 A1
(43) Pub. Date: Apr. 26, 2007

(54) Storage system

(75) Inventors: Masahiro Sone, Numazu (JP); Mitsuo Fukumori, Odawara (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/330,997

(22) Filed: Jan. 13, 2006

(30) Foreign Application Priority Data
Oct. 20, 2005 (JP) 2005-306207

(51) Int. Cl. G06F 13/00; G06F 1/32

(52) U.S. Cl. 711/113; 713/320

(57) ABSTRACT

A storage system is configured so that it can operate based on an operation mode set by an administrator from among a memory backup mode, a destage mode, a UPS mode, and a remote copy mode. The administrator can select the operation mode according to the battery capacity of the battery module, making it possible to provide a highly-convenient storage system.

### CROSS-REFERENCES TO RELATED APPLICATIONS

This application relates to and claims priority from Japanese Patent Application No. 2005-306207, filed on Oct. 20, 2005, the entire disclosure of which is incorporated herein by reference.

### BACKGROUND

The present invention relates to a storage system to which a battery module can be added as a backup power supply.

A storage system that performs data access to disk drives in response to an I/O request from a host system has cache memory that temporarily stores data to be written/read to/from the disk drives. For example, such a storage system, upon write access from a host system to disk drives, notifies the host system of the completion of the write processing when the write data has been written to the cache memory, and performs destaging when a certain amount of cache data has been accumulated. Upon read access from the host system to the disk drives, the storage system, if a cache hit has occurred for the relevant read data, can access the data at high speed by reading the data from the cache memory. Volatile memory is mostly used for this kind of cache memory. Therefore, when power supply to the cache memory is interrupted due to a power failure, cache data will be lost. For the above reason, many storage systems have a battery module as a backup power supply.

For example, JP-A-2001-147865 discloses a method wherein a first storage system, upon occurrence of an abnormality in its power system, performs remote copy of dirty data stored in its cache memory to a second storage system connected to the first storage system, and wherein the second storage system writes the dirty data to its own disk drives. The power required for the first storage system to send the dirty data to the second storage system is smaller than that required for the first storage system to write the dirty data to its own disk drives, so it is possible to save the dirty data more reliably even with small battery capacity.

### SUMMARY

Conventionally, when an abnormality occurs in a storage system power system, an operation mode to protect dirty data in the cache memory is pre-set as a function inherent to the storage system. The operation mode during a power failure cannot be selected according to the battery capacity, making flexible system operation impossible.

Therefore, an object of the present invention is to provide a storage system capable of arbitrarily selecting the operation mode for a power failure according to the battery capacity.

In order to achieve the above object, the storage system according to the present invention includes: a channel adapter that controls an interface connected to the host system; a disk drive that stores data read or written by the host system; a disk adapter that controls a back interface connected to the disk drive; a cache memory that temporarily stores data read from or written in the disk drive; and a battery module that supplies backup power to the channel adapter, the disk drive, the disk adapter, and the cache memory. The storage system operates based a preset operation mode from among: (1) a first operation mode in which, upon occurrence of a power failure, power output from the battery module is supplied to the cache memory to protect dirty data in the cache memory until recovery from the power failure; (2) a second operation mode in which, upon occurrence of a power failure, power output from the battery module is supplied to the disk drive, the disk adapter, and the cache memory in order to destage dirty data in the cache memory to the disk drive; (3) a third operation mode in which power output from the battery module is supplied to the channel adapter, the disk adapter, the cache memory, and the disk drive from the time of occurrence of a power failure until activation of an electric generator; and (4) a fourth operation mode in which, upon occurrence of a power failure, power output from the battery module is supplied to the channel adapter, and the cache memory, and dirty data in the cache memory is transmitted to an externally-connected storage system.

The present invention makes it possible to arbitrarily select the operation mode for a power failure according to the battery capacity.

### BRIEF DESCRIPTION OF THE DRAWINGS

FIG. 1 is a block diagram showing the main configuration of a storage system according to an embodiment of the present invention.

FIG. 2 is a block diagram showing the main configuration of the storage system according to the embodiment of the present invention.

FIG. 3 is a diagram showing the structure of an externally-connected apparatus control information table.

FIG. 4 is a diagram showing the structure of a recovery control information table.

FIG. 5 is a diagram showing the power system of the storage system according to the embodiment of the present invention.

FIG. 6 shows the detailed configuration of a battery module.

FIGS. 7A to 7D are diagrams explaining operation modes run during a power failure.

FIG. 8 is an external view of a management terminal.

FIG. 9 is a diagram showing an operation mode setting screen.

FIG. 10 is a diagram explaining an operation mode setting menu.

FIG. 11 is a flowchart indicating the operation of each of a memory backup mode, a destage mode, and a UPS mode.

FIG. 12 is a flowchart indicating the operation of a remote copy mode.

### DETAILED DESCRIPTION OF THE PREFERRED EMBODIMENTS

An embodiment of the present invention is explained below with reference to each of the drawings.

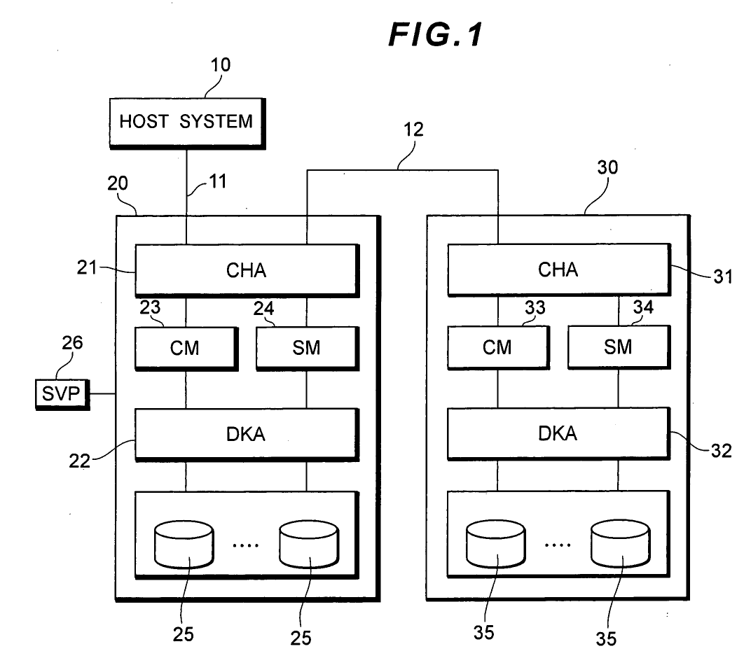

FIG. 1 shows the main configurations of storage systems 20 and 30 according to an embodiment of the present invention. The storage system 20 is connected to a host system 10 via a communication network 11. The storage system 20 and the storage system 30 are interconnected via a communication network 12. The power system to supply the storage system 20 with main power, and the power system to supply the storage system 30 with main power are different from each other, and a power failure in either of these power systems does not affect the other.

The storage system 20 includes a channel adapter (CHA) 21, a disk adapter (DKA) 22, cache memory (CM) 23, shared memory (SM) 24, disk drives 25, and a management server (SVP) 26.

The channel adapter 21 controls the host interface connected to the host system 10. The channel adapter 21 interprets commands sent from the host system 10, and controls data transfer between the host system 10 and the cache memory 23. The channel adapter 21 further includes an interface to communicate with the storage system 30, and can send dirty data (save data) in the cache memory 23 to the storage system 30.

The disk adapter 22 controls the back interface connected to the disk drives 25, and data transfer between the cache memory 23 and the shared memory 24.

The cache memory 23 temporarily stores data received from the host system 10, or data read from the disk drives 25. The cache memory 23 stores, in addition to data blocks transferred between the host system 10 and the disk drives 25, the attributes and processing status of the data blocks.

The shared memory 24, in addition to storing, amongst others, configuration information for the storage system 20, is used to convey I/O commands received by the channel adapter 21 from the host system 10 to the disk adapter 22. The shared memory 24 is non-volatile memory such as flash memory.

The disk drives 25 store data written or read by the host system 10. The disk drives 25 may be Fibre Channel disk drives, Serial ATA disk drives, Parallel ATA disk drives, or SCSI disk drives.

The management terminal 26 is used for maintenance and management of the storage system 20. Using the management terminal 26, an administrator can, for example, set logical devices defined over the disk drives 25, add or remove a disk drive 25, and change the settings for the RAID configuration (e.g. a RAID level change from RAID 5 to RAID 1).

Meanwhile, the storage system 30 includes a channel adapter 31, a disk adapter 32, cache memory 33, shared memory 34, and disk drives 35. A detailed explanation of the storage system 30 configuration is omitted since it is the same as that of the storage system 20.

The storage system 20 may have a plurality of channel adapters 21, and a plurality of disk adapters 22. Similarly, the storage system 30 may have a plurality of channel adapters 31, and a plurality of disk adapters 32. In this specification, for ease of explanation, the storage system 30 may be referred to as an externally-connected storage system, or an externally-connected apparatus from the viewpoint of the storage system 20. A plurality of storage systems 30 may be connected to the storage system 20.

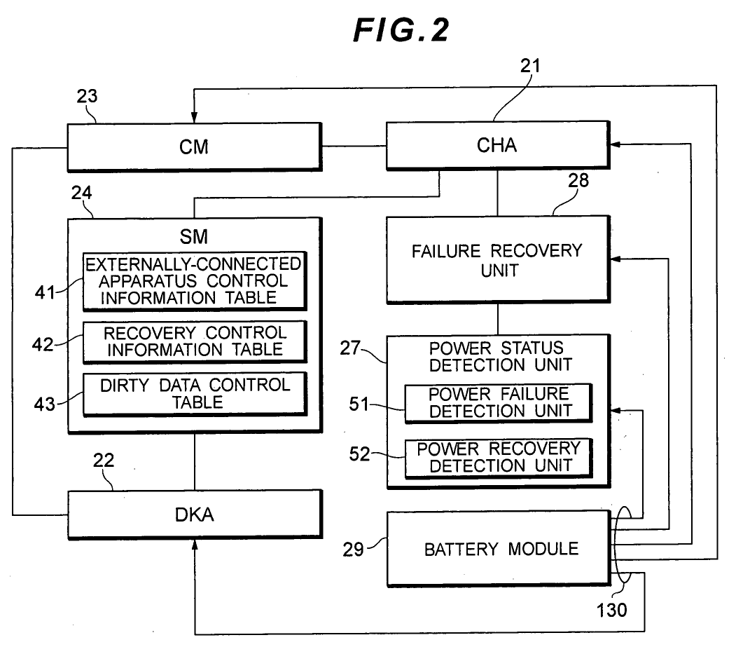

FIG. 2 shows the main configuration of the storage system 20. The storage system 20 further includes a power status detection unit 27, a failure recovery unit 28, and a battery module 29 in addition to the aforementioned configuration.

The power status detection unit 27 checks the failure status and recovery status of an AC power supply (commercial power supply) that supplies the storage system 20 with main power. The power status detection unit 27 includes a power failure detection unit 51, and a power recovery detection unit 52. The power failure detection unit 51 detects a failure in the AC power supply. The power recovery detection unit 52 detects the recovery of the AC power supply.

The failure recovery unit 28, upon being notified by the power status detection unit 27 of an AC power supply failure, controls saving of the dirty data stored in the cache memory 23. More specifically, the failure recovery unit 28 has a microprocessor; and a control program installed in the microprocessor, when the program is notified by the power failure detection unit 51 of the power failure, and the remaining battery amount in the battery module 29 reaches the limit to maintain the information in the cache memory 23, activates the channel adapter 21 to save the dirty data and control information stored in the cache memory 23 in the storage system 30, and to record the history of that data save in the recovery control information table 42 described later. When the AC power supply is recovered and the storage system 20 is rebooted, the failure recovery unit 28 activates the channel adapter 21 in order to recover the information saved in the storage system 30 to the cache memory 23.

When the power supply from the AC power supply is interrupted, the battery module 29, based on a preset operation mode, supplies power to components in the storage system 20 (e.g., a part or all of the channel adapter 21, the disk adapter 22, the cache memory 23, the disk drive 25, the power status detection unit 27, and the failure recovery unit 28) via power lines 130.

The shared memory 24 stores the externally-connected apparatus control information table 41, and the recovery control information table 42, and the dirty data control table 43. Here, the externally-connected apparatus control information table 41 is used to set a data save area in storage system 30. The recovery control information table 42 stores control information for recovering the dirty data saved in the storage system 30 to the cache memory 23. The dirty data control table 43 stores, in a bit map format, information indicating whether or not data blocks in the cache memory 23 are written in the disk drives 25 in relation to each of the data blocks, and also stores the locations where each of the data blocks is stored.

The disk adapter 22, upon the dirty data being written in a data block in the cache memory 23, accesses the dirty data control table 43, and sets the control bit for the data block to “un-reflected.” When the dirty data in the data block have been written to the disk drives 25, the disk adapter 22 updates the control bit for the data block to “reflected.”

The channel adapter 21 has a microprocessor. A control program installed in the microprocessor, upon receipt of a command from the failure recovery unit 28, sends a request to save dirty data to the storage system 30, and a request to send save information. The channel adapter 21, referring to the dirty data control table 43, transfers the dirty data and the control information for the dirty data in the cache memory 23 to the storage system 30, which is the save destination. Also, the channel adapter 21, referring to the dirty data control table 43, recovers the dirty data received from the save destination storage system 30 to the cache memory 23.

The storage system 30 also includes a power status detection unit, a failure recovery unit, and a battery module. The shared memory 34 in the storage system 30 stores things like an externally-connected apparatus control information table, a recovery control information table, and a dirty data control table.

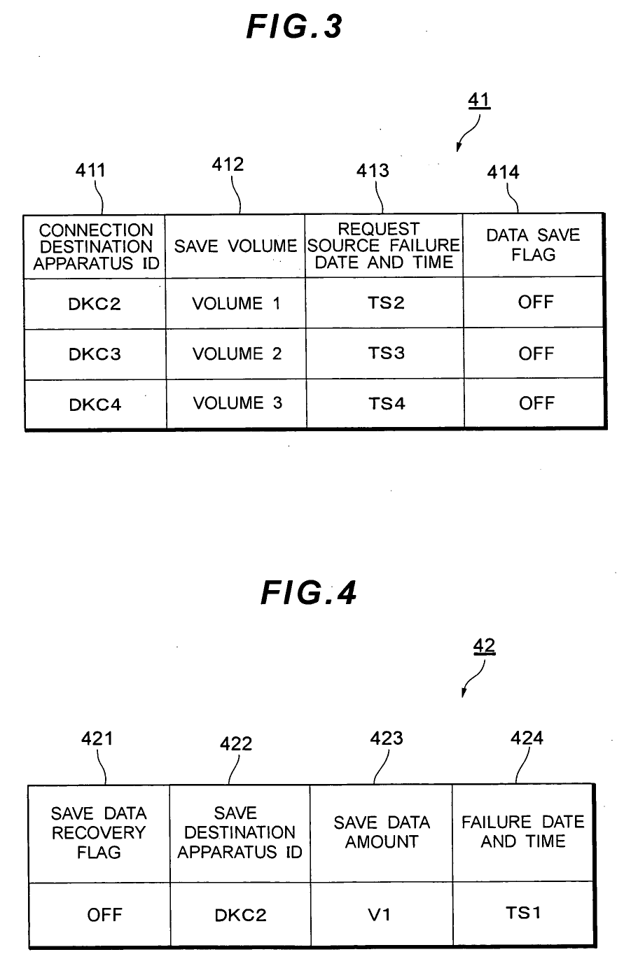

FIG. 3 shows the structure of the externally-connected apparatus control information table 41. The table 41 stores connection destination apparatus IDs 411, save volumes 412, request source failure dates and times 413, and data save flags 414. Each connection destination apparatus ID 411 is the identifier for an externally-connected storage system 30. Each save volume 412 stores a logical volume number for a save volume that has a capacity sufficient to save data stored in the cache memory 23. A logical volume in the disk drives 35 is assigned-as the save volume. When a save volume is dynamically assigned but not actually assigned yet, information indicating “unassigned” is stored in the save volume 412 column. Each request source failure date and time 413 is a date and time when the power failure has occurred, and is stored when a save request is received from the externally-connected storage system 30. Each data save flag 414 shows whether or not dirty data is saved in the externally-connected storage system 30. The initial value of a data save flag 414 is “off”(unsaved), and when dirty data has been saved, the value is set to “on” (saved).

FIG. 4 shows the structure of the recovery control information table 42. The table 42 stores a save data recovery flag 421, a save destination apparatus ID 422, a save data amount 423, and a failure date and time 424. The save data recovery flag 421 shows whether data is saved or not. The initial value of the save data recovery flag 421 is “off”(unsaved), and when dirty data has been saved, the value is set to “on” (saved). The save destination apparatus ID 422 is the identifier for the externally-connected storage system 30 in which save data exists, and is one of a plurality of connection destination apparatus IDs 411. The save data amount 423 indicates the amount of save data (dirty data). The failure date and time 424 indicates the time and date when the power failure has occurred.

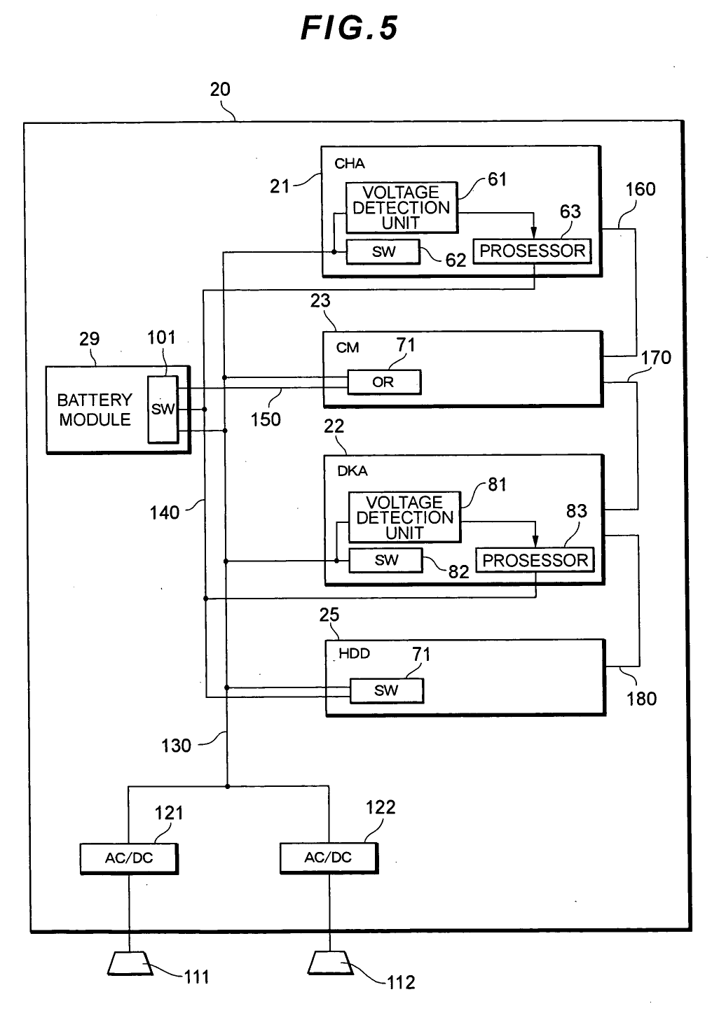

FIG. 5 shows the power system of the storage system 20. In addition to the aforementioned configuration, the storage system 20 further includes a plurality of AC input units 111 and 112, and a plurality of AC/DC converters 121 and 122. A UPS (uninterrupted power supply), or an AC power supply (commercial power supply) like an electric generator, is connected to each of the AC input units 111 and 112. The plurality of AC input systems is provided to maintain the failure tolerance (redundancy) of the system. Power converted into direct current power by the plurality of AC/DC converters 121 and 122 is supplied to the channel adapter 21, the disk adapter 22, the cache memory 23, the disk drives 25, and the battery module 29.

The channel adapter 21 includes a voltage detection unit 61, a switch 62, and a processor 63. The processor 63 controls the power supply from the power line 130 to the channel adapter 21 via the switch 62. In other words, by closing the switch 62, direct current power is supplied from the power line 130 to the channel adapter 21, while by opening the switch 62, the supply of direct current power from the power line 130 to the channel adapter 21 is interrupted. The voltage detection unit 61 regularly checks the voltage of the power line 130, and outputs a voltage detection signal to the processor 63. Based on this voltage detection signal, the processor 63 checks whether or not any power failure has occurred.

When the voltage detection signal indicates a normal value, the processor 63 in the channel adapter 21 writes data transmitted from the host system 10 to the cache memory 23 via a data transfer path 160. Meanwhile, when the voltage detection signal indicates an abnormal value, the processor 63 communicates with a processor 83 in the disk adapter 22 via a control path 140 to judge whether a failure has occurred in the AC power supply or in the channel adapter 21 (individual failure). When it judges that a failure has occurred in the AC power supply, the processor 63 interrupts data transfer from the host system 10 to the channel adapter 21, and turns the switch 62 off to disconnect a switch 101 and the power line 130 via the control path 140. Also, when it judges that the failure is an individual one occurring in the channel adapter 21, the processor 63 does the same where necessary.

The disk adapter 22 includes a voltage detection unit 81, a switch 82, and the processor 83. The processor 83 controls the power supply from the power line 130 to the disk adapter 22 via the switch 82. In other words, by closing the switch 82, direct current power is supplied from the power line 130 to the disk adapter 22, while the supply of direct current power from the power line 130 to the disk adapter 22 is interrupted by opening the switch 82. The voltage detection unit 81.regularly checks the voltage of the power line 130, and outputs a voltage detection signal to the processor 83. Based on this voltage detection signal, the processor 83 checks whether or not any power failure has occurred.

When the voltage detection signal indicates a normal value, the processor 83 in the disk adapter 22 reads dirty data in the cache memory 23 via a data transfer path 170, and writes it to the disk drives 25 via a data transfer path 180. Meanwhile, when the voltage detection signal indicates an abnormal value, the processor 83 communicates with the processor 63 in the channel adapter 21 via the control path 140 to judge whether a failure has occurred in the AC power supply or in the channel adapter 21 (individual failure). When it judges that the failure has occurred in the AC power supply, the processor 83 turns the switch 82 off and also turns a switch 91 for the disk drives 25 off via the control path 140. Also, when it judges that the failure is an individual one occurring in the channel adapter 22, the processor 83 does the same where necessary.

In addition to the aforementioned processing, the processor 83 in the disk adapter 22, for example, monitors the status of the cache memory 23 via the data transfer path 170 and also the status of the disk drives 25 via the data transfer path 180. The disk adapter 22, where necessary, interrupts the processing to write data in the cache memory 23 to the disk drives 25.

The cache memory 23 includes an OR circuit 71. The OR circuit 71, when the AC power supply is normal, supplies power from the AC power supply to the cache memory 23 via the power line 130, and when the AC power supply is abnormal, supplies power from the battery module 29 to the cache memory 23 via a power line 150.

The disk drives 25 include the switch 91. The switch 91 controls power supply from the power line 130 to the disk drives 25. Direct current power is supplied from the power line 130 to the disk drives 25 by closing the switch 91, while direct current power from the power line 130 to the disk drives 25 is interrupted by opening the switch 91.

The battery module 29 includes the switch 101. The switch 101 controls the connection between the power line 130 and the battery module 29, or the connection between the power line 150 and the battery module 29 in accordance with control from the processor 63 or the processor 83. The battery module 29, when the AC power supply is normal, is charged with power via the power line 130. At this time, power is supplied from the power line 130 to the channel adapter 21, the disk adapter 22, the cache memory 23, and the disk drives 25. Meanwhile, when an abnormality occurs in the AC power supply, power is supplied from the battery module 29 to the cache memory 23 via the power line 150.

The battery module 29 is extendable, and when a plurality of battery modules 29 is mounted, the battery modules 29 operate in parallel.

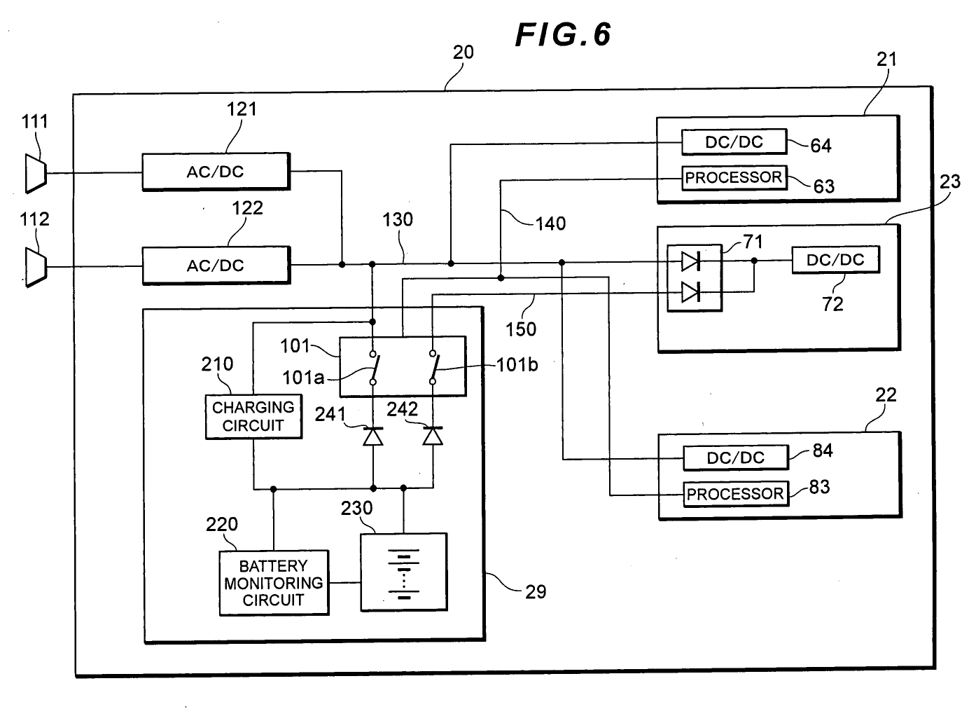

FIG. 6 shows the detailed configuration of the battery module 29. The battery module 29 includes, in addition to the aforementioned switch 101, a charging circuit 210, a battery monitoring circuit 220, and a battery unit 230.

The switch 101 has a normally-closed contact 101a that is normally connected to the power line 130, and a normally-closed contact 101b that is normally connected to the power line 150. The switch 101 is provided with the two normally-closed contacts 101a and 101b so that power supply to the loads (the channel adapter 21, the disk adapter 22, the cache memory 23, and the disk drives 25, etc.) can be switched smoothly from the AC power supply to the battery module 29 when a failure occurs in the AC power supply.

The battery unit 230 is an assembled battery configured by a plurality of batteries being connected in series. For the batteries, for example, nickel hydride batteries can be used. The rated output of the battery unit 230 is set to be lower than that of each of the AC/DC converters 121 and 122. For example, assuming that the rated output of each of the AC/DC converters 121 and 122 is 56V, the rated output of the battery unit 230 will be around 54V to 36V. 36V is the minimum value for the operating voltage of a communication device.

When the AC power supply is normal, the charging circuit 210 charges the battery unit 230 with the direct current power supplied from the AC/DC converters 121 and 122 via the power line 130. The charge accumulated in the battery unit 230 through the above process flows to the power line 130 via a backflow prevention diode 241 and the normally-closed contact 101a when the output voltage of each of the AC/DC converters 121 and 122 falls below the full-charged voltage of the battery unit 230 (e.g., 54V) due to a failure occurring in the AC power supply. The charge that flows into the power line 130 flows in the channel adapter 21, the disk adapter 22, the cache memory 23, the disk drives 25, etc., and supplies them with power.

When the normally-closed contact 101a is opened, controlled by the processor 83 in the disk adapter 22 during a power failure in the AC power supply, the charge accumulated in the battery unit 230 flows into the power line 150 via a backflow prevention diode 242 and the normally-closed contact 101b. The charge that flows into the power line 150 flows in the cache memory 23, and supplies it with power.

The battery monitoring circuit 220 self-checks whether the voltage fluctuation of the battery unit 230 remains within a certain range, by monitoring the voltage of the charge in the battery unit 230.

The channel adapter 21, the disk adapter 22, and the cache memory 23 respectively include DC/DC converters 64, 84, and 72 that lower the direct current voltage supplied respectively to the channel adapter 21, the disk adapter 22, and the cache memory 23 via the power line 130 to a desired direct current voltage.

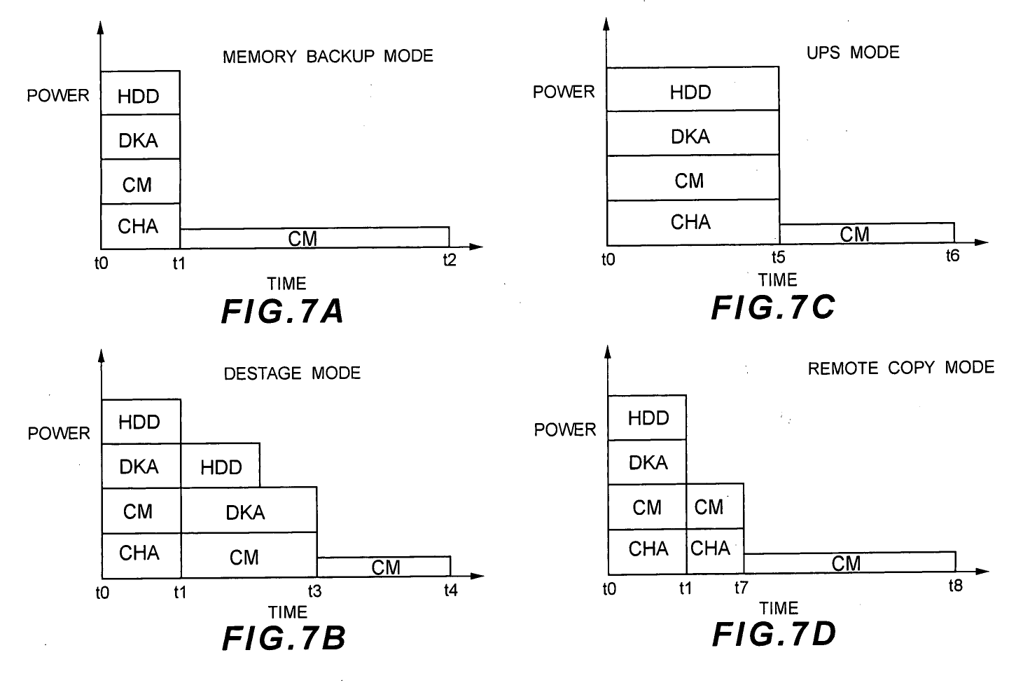

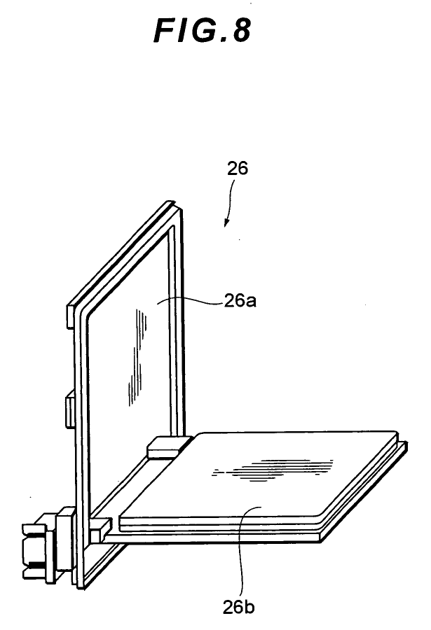

FIGS. 7A to 7D show operation modes that operate during a failure. In this embodiment, four types of operation modes are illustrated. FIG. 7A shows a memory backup mode, FIG. 7B shows a destage mode, FIG. 7C shows a UPS mode, and FIG. 7D shows a remote copy mode. Based on the preset operation mode, the processor 63 in the channel adapter 21, or the processor 83 in the disk adapter 22 controls switches 62, 82, 91, and 101 to control the supply of power from the battery module 29 to the loads (a part or all of the channel adapter 21, the disk adapter 22, the cache memory 23, and the disk drives 25). A further explanation of each of the operation modes will be given below.

The memory backup mode is an operation mode to continuously supply power from the battery module 29 to only the cache memory 23 during a failure occurring in the AC power supply so as to retain dirty data for a long time until the system recovers. As shown in FIG. 7A, the storage system 20, upon detecting a power failure at time t0, continues to maintain the power supply from the battery module 29 to the loads (all of the channel adapter 21, the disk adapter 22, the cache memory 23, and the disk drives 25) from time to t0 time t1 (e.g., one minute). For the period from time t1 to time t2, the storage system 20 continues to supply power from the battery module 29 to only the cache memory 23.

Even if a power failure in the AC power supply is detected, power supply to the loads (all of the channel adapter 21, the disk adapter 22, the cache memory 23, and the disk drives 25) continues to be maintained for a certain time. This is because, since in most cases a power failure is caused by lighting or switching in the power transmission system or the like and lasts only for a few seconds, continuing the operation of the storage system 20 for around one minute can prevent the storage system 20 from being shut down due to a only momentary power failure. Another reason is that, when a power failure in the AC power supply lasts for one minute or more, it is necessary to perform processing to deal with the power failure on the host system 10 side, too, and if the operation of the storage system 20 halts due to a momentary power failure, it is impossible to complete processing to deal with the power failure on the host system 10 side, and therefore, it will consume a lot of time to boot up the entire system (including the host system 10 and the storage system 20) after the recovery from the power failure.

The destage mode is an operation mode to, during a power failure in the AC power supply, destage dirty data in the cache memory 23 to each of a plurality of disk drives 25, and upon the completion of the destaging, turn off the power to the disk drives 25. As shown in FIG. 7B, the storage system 20, upon detecting a power failure at time t0, continues to maintain the power supply from the battery module 29 to the loads (all of the channel adapter 21, the disk adapter 22, the cache memory 23, and the disk drives 25) for the period from time t0 to time t1 (e.g. one minute). For the period from time t1 to time t3, the storage system 20 destages dirty data in the cache memory 23 to the disk drives 25. Then the disk drives 25 are each sequentially turned off upon completion of their destaging. For the period from the time t3 to the time t4, the storage system 20 continues to supply power from the battery module 29 to only the cache memory 23.

The UPS mode is an operation mode to continuously supply power from the battery module 29 to the loads (all of the channel adapter 21, the disk adapter 22, the cache memory 23, and the disk drives 25) for the period from the time when a power failure occurs in the AC power supply until the electric generator activates, and after the activation of the electric generator, to continuously supply power output from the electric generator to only the cache memory 23. The UPS mode setting is subject to an electric generator being connected to the AC input units 111 and 112. As shown in FIG. 7C, the storage system 20, upon detecting a power failure at time t0, continues to maintain the power supply from the battery module 29 to the loads (all of the channel adapter 21, the disk adapter 22, the cache memory 23, and the disk drives 25) for the period from time t0 to time t5 (e.g., six minutes). The period from time t0 to time t5 may be any period of time necessary to activate the electric generator. For time t5 to time t6, the storage system 20 supplies power output from the electric generator to only the cache memory 23.

The remote copy mode is an operation mode to, during a power failure occurring in the AC power supply, transmit dirty data in the cache memory 23 to an externally-connected storage system 30, and upon the completion of the dirty data transmission, turn off the power to the channel adapter 21. The remote copy mode setting is subject to the storage system 20 being connected to one or more storage systems 30. As shown in FIG. 7D, the storage system 20, upon detecting a power failure at time t0, continues to maintain the power supply from the battery module 29 to the loads (all of the channel adapter 21, the disk adapter 22, the cache memory 23, and the disk drives 25) for the period from time t0 to time t1 (e.g., one minute). Then for the period from time t1 to time t7, the storage system 20 transmits dirty data in the cache memory 23 to the storage system 30. The storage system 30 then destages the dirty data received from the storage system 20 to the disk drives 35. The storage system 20, upon the completion of the dirty data transmission, turns off the power to the channel adapter 21. For the period from time t7 to time t8, the storage system 20 continues to supply power from the battery module 29 to only the cache memory 23.

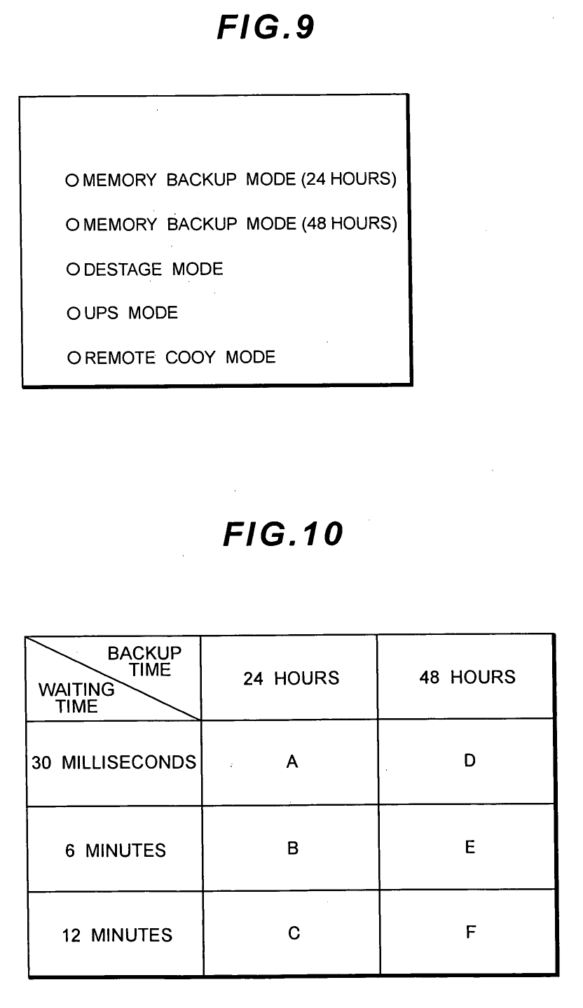

FIG. 8 shows the external appearance of the management terminal 26. The management terminal 26 includes a display 26a, and an input device 26b. The input device 26b may be a keyboard, a mouse or the like. The display 26a shows a setting screen shown in FIG. 9. An administrator, referring to this setting screen, sets the operation mode that operates during a power failure. In this example, two types of memory backup mode—a 24-hour backup mode, and a 48-hour backup mode —are shown.

In this embodiment, an administrator for the storage system 20 can arbitrarily increase or decrease the number of mounted battery modules 29. Also the administrator can connect an electric generator to each of the AC input units 111 and 112 of the storage system 20. The administrator can select the optimum mode from among the aforementioned four types of operation mode according to the number of the battery modules 29 mounted and the performance of the electric generator as well as the system configuration of the storage system 20. For example, as shown in FIG. 10, it is assumed that two types of memory backup time for the cache memory 23, i.e., 24 hours and 48 hours can be set, and that three types of time for waiting for the electric generator to activate (the period of time from the occurrence of a power failure to the activation of the electric generator), i.e., 30 milliseconds, 6 minutes, and 12 minutes can be set. As can be seen from A to F in the table, six types of variations can exist. The administrator can select the optimum mode from among the memory backup mode, the destage mode, the UPS mode, and the remote copy mode with regard to each of the variations A to F.

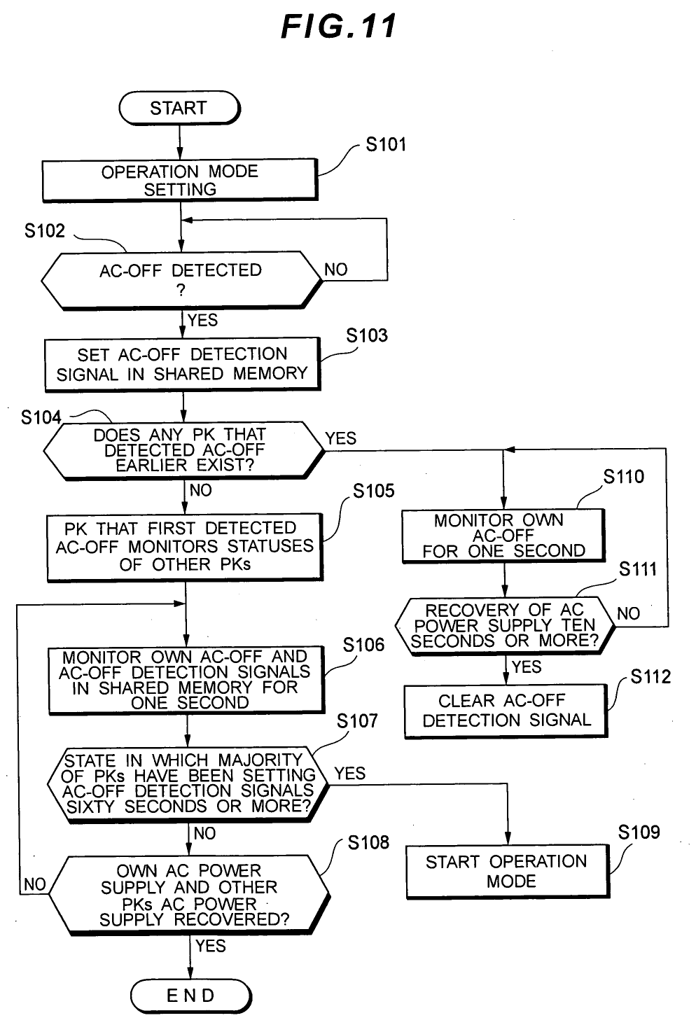

FIG. 11 is a flowchart indicating the process for any of the memory backup mode, the destage mode, and the UPS mode. For ease of explanation, a “PK” shall collectively refer to the channel adapter 21 and the disk adapter 22.

The administrator, referring to the setting screen shown on the display 26a of the management terminal 26, uses the input device 26b to configure settings to any operation mode from among the memory backup mode, the destage mode, and the UPS mode (S101).

The PK, upon detecting a failure in the AC power supply (S102: YES), sets an AC-off detection signal in the shared memory 24 (S103). The AC-off detection signal is a signal indicating occurrence of a failure in the AC power supply.

If no other PK exists that set an AC-off detection signal in the shared memory 24 earlier than the PK that set the AC-off detection signal in the shared memory 24 at S102 (S1 04: NO), the PK that first set the AC-off detection signal in the shared memory 24 monitors the states of other PKs (S105).

Next, the PK that first set the AC-off detection signal in the shared memory 24 monitors, for one second, whether or not a failure exists in its own power supply, and whether or not any other AC-off detection signal set in the shared memory 24 exists (S106).

If the time for which a majority of the PKs have been setting AC-off detection signals in the shared memory 24 is 60 seconds or more (S107: YES), it can be considered that a failure has occurred in the AC power supply, so the operation mode set at S101 starts to run (S109). If the operation mode set is the memory backup mode, the operation shown in FIG. 7A is executed. If the operation mode set is the destage mode, the operation shown in FIG. 7B is executed. If the operation mode set is the UPS mode, the operation shown in FIG. 7C is executed.

If the time for which a majority of the PKs have been setting AC-off detection signals in the shared memory 24 is less than 60 seconds (S107: NO), the PK that first set the AC-off detection signal in the shared memory 24 checks whether its own AC power supply and the AC power supplies for the other PKs have recovered (S 108).

If the AC power supplies have not recovered yet (S108: NO), the PK returns to the processing at S106. If the AC power supplies have recovered (S108: YES), the PK ends the processing.

Meanwhile, if any PK exists that set an AC-off detection signal in the shared memory 24 earlier than the PK that set the AC-off detection signal at S102 (S104: YES), the PK that set the AC-off detection signal later monitors the state of its own AC power supply for one second (S110), and if the AC power supply has not recovered for ten seconds or more (S111: NO), returns to the processing at S110. If the AC power supply has recovered for ten seconds or more (S111: YES), the AC-off detection signal set in the shared memory 24 is cleared (S112).

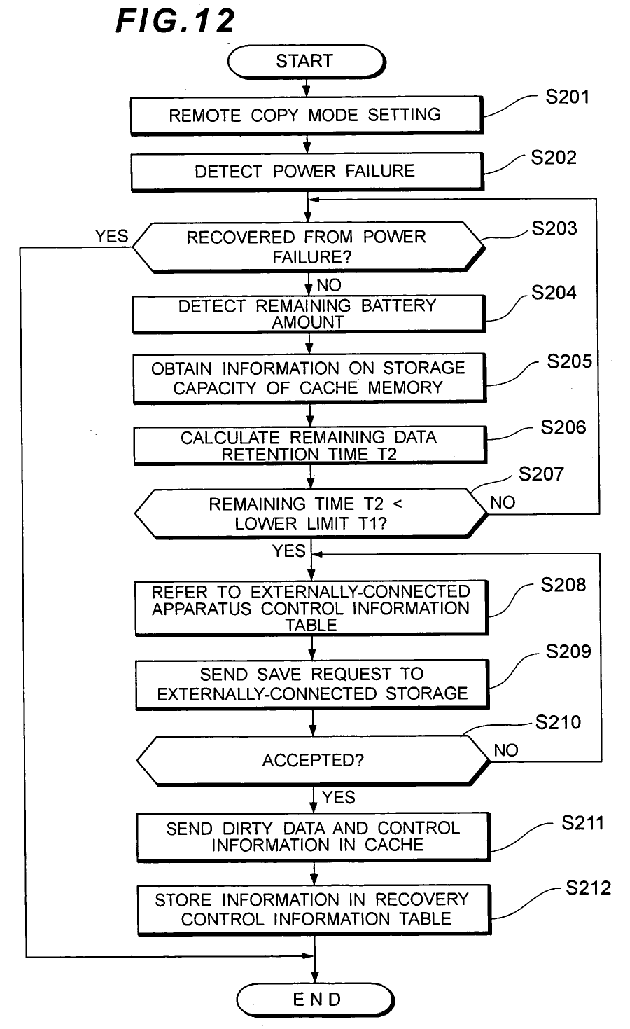

FIG. 12 is a flowchart indicating the process for the remote copy mode.

The administrator, referring to the setting screen shown on the display 26a in the management terminal 26, uses the input device 26b to configure settings to the remote copy mode (S201).

The power failure detection unit 51, upon detecting a failure in the AC power supply (S202), notifies the failure recovery unit 28 of the occurrence of the power failure. The failure recovery unit 28, if not notified by the power recovery detection unit 52 of recovery of the AC power supply (S203: NO), detects the remaining battery amount in the battery module 29 (S204). The remaining battery amount is represented by the remaining amount of power in the battery module 29 (e.g., a numeric value in watt hours).

Next, the failure recovery unit 28, referring to the configuration management table (not shown) stored in the shared memory 24, obtains information on the storage capacity (MB) of the cache memory 23 (S205).

Next, the failure recovery unit 28 calculates remaining time T2 the battery module 29 can retain data in the cache memory 23 (S206). The time T2 can be calculated according to the following formula: the remaining battery amount ÷[(power amount required to maintain 1 MB data in the cache memory 23)×(storage capacity of the cache memory 23)].

Next, the failure recovery unit 28 compares the time T2 and the lower limit value for data retention time T1, and if T2 ≧T1 (S207: NO), returns to S203, and waits for recovery from the power failure. If the failure recovery unit 28 is notified by the power recovery detection unit 52 of power supply recovery while T2 ≧T1 (S203: YES), it regards the AC power supply as having been recovered from the failure, and does not execute processing to save dirty data stored in the cache memory 23.

If T2 <T1 (S207: YES), the failure recovery unit 28, referring to the first entry in the connection destination apparatus ID 411 column of the externally-connected apparatus control information table 41 (S208), transmits a data save request to the storage system 30 (S209). At this time, information on the amount of dirty data stored in the cache memory 23 (i.e., save-data amount) and the date and time when the failure has occurred are transmitted together with the data save request to the storage system 30.

If the data save request is not accepted (S210: NO), the failure recovery unit 28 returns to S208, and referring to the second entry in the connection destination apparatus ID 411 column of the externally-connected apparatus control information table 41, repeats the processing at S209 and S210. When the processing at S209 and S210 has been repeated for all of the entries in the connection destination apparatus ID 411 column of the externally-connected apparatus control information table 41, the processing ends.

If the data save request is accepted (S210: YES), the channel adapter 21, referring to the dirty data control table 43, transmits dirty data and its control information in the cache memory 23 to the storage system 30 in the order the dirty data was stored in the cache (S211). The data and control information in the cache memory 23 may be transmitted to the storage system 30 regardless of whether it is clean data or dirty data. However, in transferring only dirty data to the storage system 30, there is the advantage of data transfer time being reduced.

The failure recovery unit 28, upon receiving a status signal from the storage system 30 informing it of the completion of the reception, sets the save data recovery flag 421 in the recovery control information table 42 to “on,” stores the ID for the storage system 30 in the save destination apparatus ID 422 column, stores the dirty data amount in the save data amount 423 column, and stores the date and time when the AC power supply failure occurred in the failure date and time 424 column (S212).

According to this embodiment, an optimum operation mode can be selected from among the memory backup mode, the destage mode, the UPS mode, and the remote copy mode based on the battery capacity in the battery module 29.

What is claimed is:

1. A storage system for performing data processing in response to an I/O request from a host system, the storage system comprising:
a channel adapter that controls an interface connected to the host system;
a disk drive that stores data read or written by the host system;
a disk adapter that controls a back interface connected to the disk drive;
a cache memory that temporarily stores data read from or written in the disk drive; and
a battery module that supplies backup power to the channel adapter, the disk drive, the disk adapter, and the cache memory;
wherein the storage system operates based on a preset operation mode from among:
a first operation mode in which, upon occurrence of a power failure, power output from the battery module is supplied to the cache memory to protect dirty data in the cache memory until recovery from the power failure;
a second operation mode in which, upon occurrence of a power failure, power output from the battery module is supplied to the disk drive, the disk adapter, and the cache memory in order to destage dirty data in the cache memory to the disk drive;
a third operation mode in which power output from the battery module is supplied to the channel adapter, the disk adapter, the cache memory, and the disk drive from the time of occurrence of a power failure until activation of an electric generator; and
a fourth operation mode in which, upon occurrence of a power failure, power output from the battery module is supplied to the channel adapter, and the cache memory, and dirty data in the cache memory is transmitted to an externally-connected storage system.

2. The storage system according to claim 1, wherein the battery module is extendable.

3. The storage system according to claim 2 further comprising a management terminal for an administrator to use to set the operation mode to one of the first operation mode, the second operation mode, the third operation mode, and the fourth operation mode according to the battery capacity in the battery module.

4. The storage system according to claim 1 further comprising a management terminal for an administrator to use to set the operation mode to one of the first operation mode, the second operation mode, the third operation mode, and the fourth operation mode according to the time from the occurrence of a power failure until activation of the electric generator.
